(19) United States
(12) Patent Application Publication
(10) Pub. No.: US 2011/0203716 A1
(43) Pub. Date: Aug. 25, 2011

(54) LABEL PAPER PROCESSING IN A LABEL PRODUCING DEVICE

(75) Inventor: Norihisa Shiraishi, Shizuoka (JP)

(73) Assignee: TOSHIBA TEC KABUSHIKI KAISHA, Tokyo (JP)

(21) Appl. No.: 12/860,514

(22) Filed: Aug. 20, 2010

(30) Foreign Application Priority Data
Feb. 24, 2010 (JP) 2010-039198

(51) Int. Cl. B32B 41/00; B65C 9/06

(52) U.S. Cl. 156/64; 156/354

(57) ABSTRACT

According to one embodiment, a label producing device includes a feeding unit, a detecting unit and a controller coupled to the detecting unit. The feeding unit may be configured to feed a label paper along a paper path. The label paper may have a plurality of labels affixed thereon. The detecting unit may be configured to detect a transmittance or a thickness of the label paper. The CPU may be configured to identify a label free portion of the label paper. In one embodiment, the label free portion of the label paper may be identified based on the detected transmittance or thickness. The CPU may be further configured to determine a cut point in the label free portion.

### CROSS-REFERENCE TO RELATED APPLICATIONS

This application is based upon and claims the benefit of priority from Japanese Patent Application No. 2010-039198 filed on Feb. 24, 2010, the entire contents of which is incorporated herein by reference.

### FIELD

Embodiments described herein relate generally to label paper processing in a label producing device to process a label paper having a mount and a plurality of labels affixed onto the front and rear surfaces of the mount to separate the individual labels therefrom.

### BACKGROUND

Conventionally, there has been known a label producing device (e.g., label printer) that may produce a label paper having a mount and a plurality of labels having predetermined information printed thereon and affixed onto the mount. The conventional label producing device may be equipped with a mechanism to detect cut points called “black marks”, which are typically printed on the rear surface of the mount between the portions of the mount the labels are affixed to. The use of the mechanism may allow the label paper to be properly cut to produce defect-free labels.

The conventional label producing device having the above mechanism may operate to determine a point midway between positive and negative pulses, which indicate the edges of the labels, and set the determined point as a cut point.

While the conventional label producing device may exhibit fairly reliable cut point detection results for a label paper with labels affixed onto only one surface of its mount, it proved inadequate for the detection of cut points on a label paper with labels affixed onto both the front and rear surfaces of its mount.

### BRIEF DESCRIPTION OF THE DRAWINGS

FIG. 1 is a first illustrative embodiment of a side elevational view of a label producing device.

FIG. 2 is a second illustrative embodiment of a side elevational view of a label producing device.

FIG. 3 is an illustrative embodiment of a functional block diagram of a label producing device.

FIG. 4 is an illustrative embodiment of a diagram for explaining a structure of an exemplary label paper to be processed by a label producing device.

FIG. 5 is an illustrative embodiment of a flowchart for explaining an example of mount cut processing in a label producing device.

FIG. 6 is an illustrative embodiment of a flowchart for explaining an example of label paper condition identification processing in the label producing device.

FIG. 7 is an illustrative embodiment of an enlarged sectional view showing an example of a label paper to be processed by a label producing device.

### DETAILED DESCRIPTION

According to an exemplary embodiment, a label producing device is provided. The label producing device includes a feeding unit, a detecting unit and a controller coupled to the detecting unit. The feeding unit may be configured to feed a label paper along a paper path. The label paper may have a plurality of labels affixed thereon. The detecting unit may be configured to detect a transmittance or a thickness of the label paper. The CPU may be configured to identify a label free portion of the label paper. In one embodiment, the label free portion of the label paper may be identified based on the detected transmittance or thickness. The CPU may be further configured to determine a cut point in the label free portion. The label producing device may further include a cutting unit configured to cut the label paper at the cut point.

In one embodiment, the CPU may determine a lengthwise center of the label free portion as the cut point. In another embodiment, the CPU may be further configured to identify the label free portion of the label paper by checking whether the detected transmittance or thickness is within a predetermined range. In one embodiment, the detecting unit may be configured to detect the transmittance or the thickness of the label paper while the label paper is fed along the paper path.

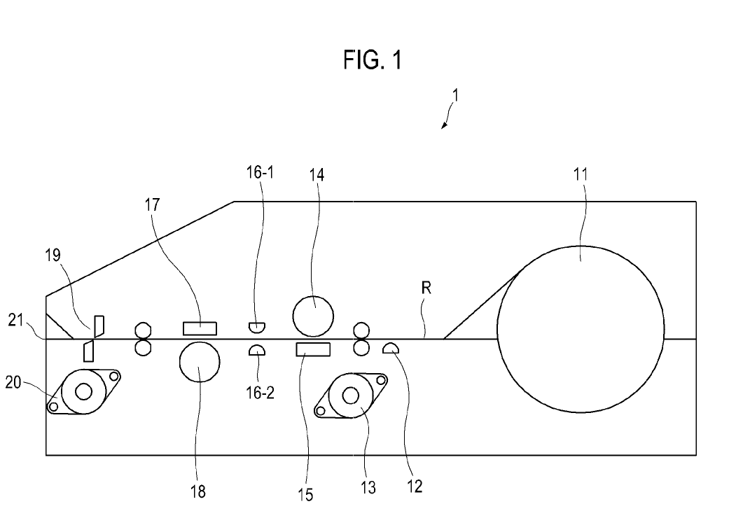

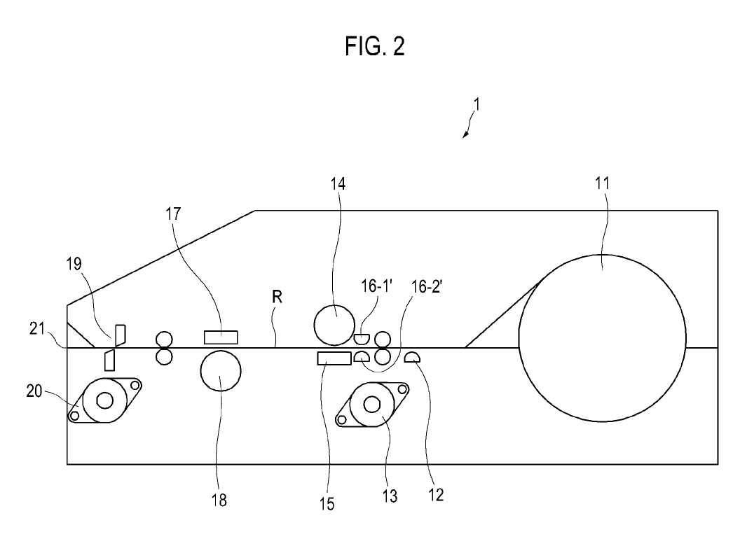

Embodiments will now be described in detail with reference to the drawings. FIG. 1 shows a first illustrative embodiment of a side elevational view of a label producing device. FIG. 2 shows a second illustrative embodiment of a side elevational view of a label producing device. As shown in FIG. 1, a label producing device 1 of an illustrative embodiment may include a roll label paper 11, a reflective photo-sensor 12 configured to detect a mount with a plurality of labels affixed thereon, a transport motor 13 configured to convey the mount along a paper path R, a rear thermal head 15 configured to print data on the plurality of labels affixed on the rear surface of the mount, and a rear platen roller 14 mounted opposite the rear thermal head 15. The label producing device 1 may further include a pair of transparent photo-sensors 16-1 and 16-2 configured to detect a gap between the labels affixed on the mount, a front thermal head 17 configured to print data on a plurality of labels affixed on the front surface of the mount, a front platen roller 18 mounted opposite the front thermal head 17, a cutter 19 configured to cut the mount, a cutting motor 20 configured to drive the cutter 19, and an outlet 21 through which printed labels are ejected to the exterior. Note that the label producing device illustrated in FIG. 1 is similar to that illustrated in FIG. 2 except that in FIG. 1, the pair of transparent photo-sensors 16-1, 16-2 are placed between the front and rear thermal heads 17 and 15, while in FIG. 2, a pair of transparent photo-sensors 16-1′, 16-2′ are placed between the reflective photo-sensor 12 and the rear thermal head 15.

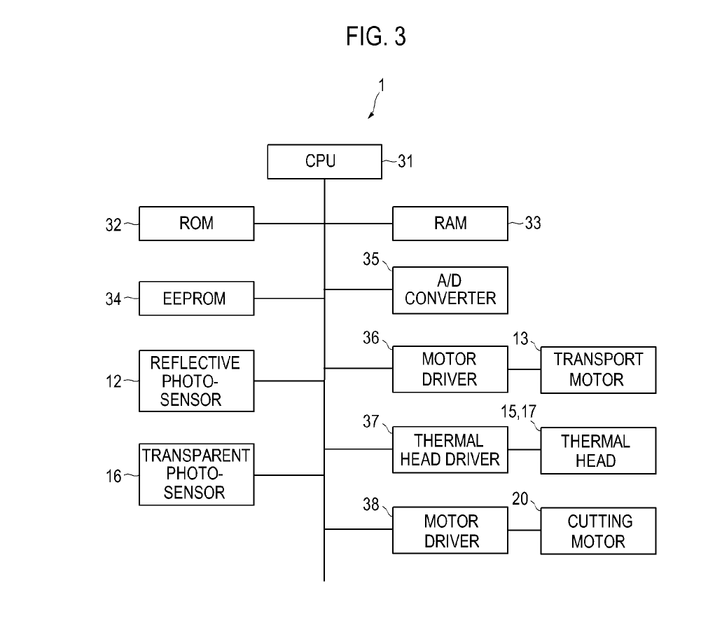

FIG. 3 shows an illustrative embodiment of a functional block diagram of a label producing device. As shown in FIG. 3, the label producing device 1 of an illustrative embodiment may include a CPU 31 configured to control the overall operations of the label producing device 1, a ROM 32 to store operation programs therein, a RAM 33 to store operation programs or control information therein, and an EEPROM 34 to store operation programs or control information therein. The CPU 31 may be coupled to the reflective photo-sensor 12 and the pair of transparent photo-sensors 16-1 and 16-2. The label producing device 1 may further comprise an A/D converter 35 configured to convert analog signals provided by the transparent photo-sensors 16-1 and 16-2 and the reflective photo-sensor 12 into digital signals, a motor driver 36 configured to drive the transport motor 13, a thermal head driver 37 configured to drive the front thermal head 17 and the rear thermal head 15, and a motor driver 38 configured to drive the cutting motor 20.

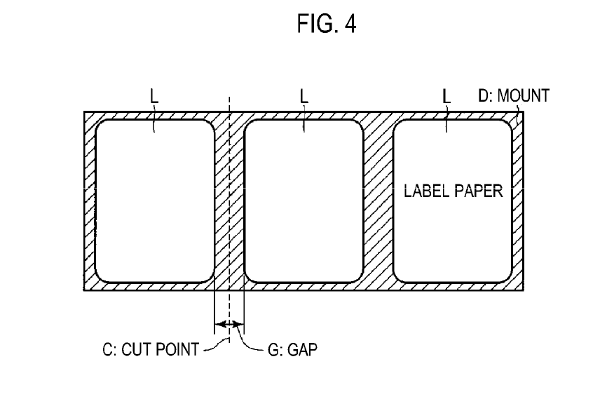

FIG. 4 shows an illustrative embodiment of a diagram for explaining a structure of an exemplary label paper to be processed by a label producing device. As shown in FIG. 4, a mount D having a plurality of labels L thereon may be wrapped in a roll-shape. The plurality of labels L may be affixed onto the mount D at regular intervals. A cut point C may be located midway in the gap G between the respective two adjacent labels L.

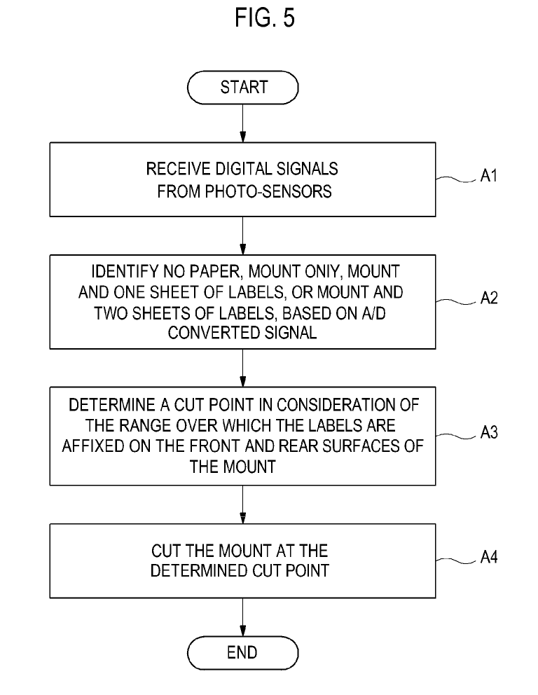

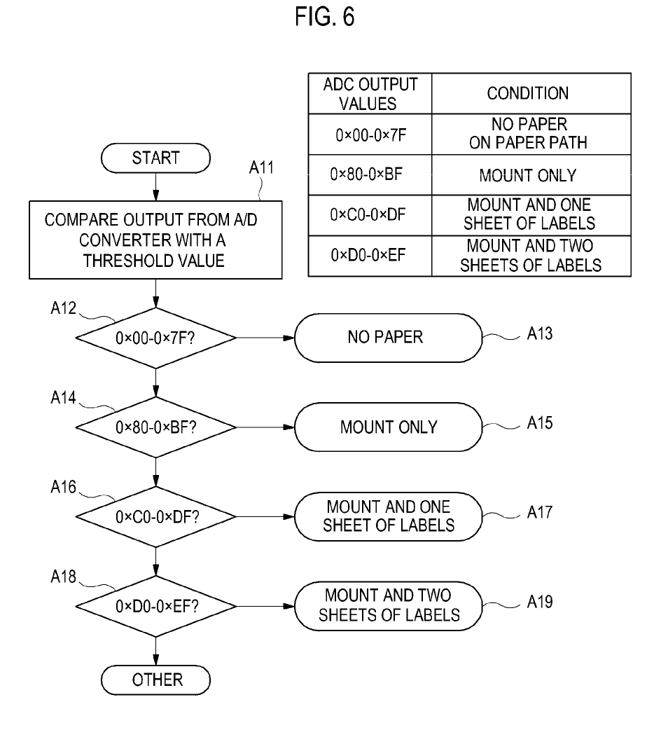

With reference to FIGS. 5 and 6, which show an illustrative embodiment of a flowchart for explaining an example of mount cut processing in a label producing device, and an illustrative embodiment of a flowchart for explaining an example of label paper condition identification processing in the label producing device, respectively, descriptions will be made of mount cut processing and label paper condition identification processing in the label producing device of an illustrative embodiment. In the label producing device 1, the CPU 31 may control the motor driver 36 to drive the transport motor 13 to thereby allow the roll label paper 11 to be conveyed along the paper path R. If the reflective photo-sensor 12 detects the presence of the mount D on the paper path R, it provides a signal indicating the detection. In response to the signal, the CPU 31 may control the rear platen roller 14 and the rear thermal head 15 to have print operations performed on the labels L that are affixed on the rear surface of the mount D. In the same manner, the CPU 31 may control the front thermal head 17 and the front platen roller 18 to have print operations performed on the labels L that are affixed on the front surface of the mount D. While the mount D is conveyed along the paper path R by the paper transport motor 13, the pair of transparent photo-sensors 16-1 and 16-2 may provide an analog signal indicating a transmittance value of the label paper and the CPU 31 may receive a digital signal corresponding to the analog signal (act A1). In this case, the CPU 31 may control the A/D converter 35 to convert the analog signal into digital form. Based on a data value of the converted digital signal, the CPU 31 may identify the label paper to be placed in one of the following conditions: a No-Paper condition, a Mount-only condition, a Mount and One-Sheet-of-Labels condition, and a Mount and Two-Sheets-of-Labels condition (act A2).

As shown in FIG. 6, the CPU 31 may compare the digital signal, i.e., the output from the A/D converter 35 with a threshold value (act A11). For example, the CPU 31 may check whether the digital signal is 0x00-0x7F or not (act A12). If the checked result is YES, the CPU 31 may determine the label paper to be placed in the No-Paper condition (act A13). If the checked result is NO, the process goes to act A14 where the CPU 31 may check whether the digital signal is 0x80-0xBF or not. If the checked result is YES, the CPU 31 may determine the label paper to be placed in the Mount-only condition (act A15). If the checked result is NO, the process goes to act A16 where the CPU 31 may check whether the digital signal is 0xC0xDF or not. If the checked result is YES, the CPU 31 may determine the label paper to be placed in the Mount and One-Sheet-of-Labels condition (act A17). If the checked result is NO, the process goes to act A18 where the CPU 31 may check whether the digital signal is 0xD0-0xEF or not. If the checked result is YES, the CPU 31 may determine the label paper to be placed in the Mount and Two-Sheets-of-Labels condition (act A19). If the checked result is NO, the process goes to act A20 where the CPU 31 may determine the label paper to be placed in an abnormal condition, for example.

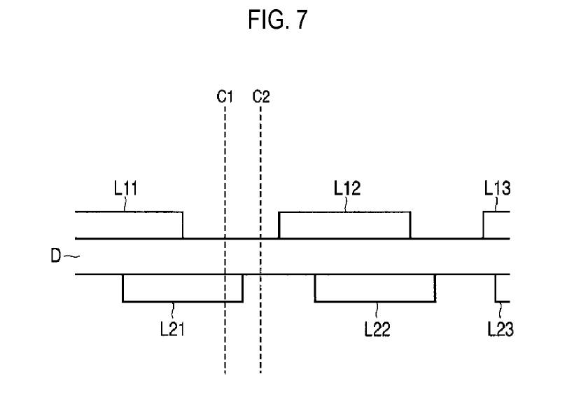

Note that on the mount D with a plurality of labels affixed on both of its front and rear surfaces, it is desirable for each pair of labels, which are affixed on the mount D in an opposite relationship with each other, to be in exact alignment. However, as shown in FIG. 7, the pair of labels L are misaligned or not in line with each other on the front and rear surfaces of the mount D. For the label paper illustrated in FIG. 7, cutting the label paper based on a cut point determined with reference to only one label (e.g., L11) affixed on the front surface of the mount D would cause a portion of label L21 affixed on the rear surface of the mount D to be mistakenly truncated.

As such, as mentioned in FIG. 6, the CPU 31 may consider the range over which the pair of labels are affixed on the front and rear surfaces of the mount D in determining a cut point. In one embodiment, the range may be determined based on the condition of the label paper (4 conditions explained above in conjunction with FIG. 6). In case of the label paper illustrated in FIG. 7, the CPU 31 may determine a point C2 as a cut point in consideration of the range, over which the labels L11 and L21 are affixed on the front and rear surfaces of the mount D (act A3). With such determination, the label L11 can be prevented from being mistakenly truncated. Particularly, the CPU 31 may operate to check the successive points on the label paper to categorize the respective points into one of a portion of the mount having one sheet of labels, a portion of the mount having two sheets of labels, and a portion of the mount free of any labels. Based on the categorization, the CPU 31 may operate to define, as a cut point, a center of a span of the points categorized as belonging to the portion of the mount free of a label. In one embodiment, the center may be a lengthwise center of the points on the paper path, along which the label paper is fed. In this way, the risk of labels being truncated can be prevented. Next, the CPU 31 may control the cutter 19 to cut the mount D at the defined cut points (act A4).

As used in this application, entities for executing the actions can refer to a computer-related entity, either hardware, a combination of hardware and software, software, or software in execution. For example, an entity for executing an action can be, but is not limited to being, a process running on a processor, a processor, an object, an executable, a thread of execution, a program, and a computer. By way of illustration, both an application running on an apparatus and the apparatus can be an entity. One or more entities can reside within a process and/or thread of execution and a entity can be localized on one apparatus and/or distributed between two or more apparatuses.

The program for realizing the functions can be recorded in the apparatus, can be downloaded through a network to the apparatus and can be installed in the apparatus from a computer readable storage medium storing the program therein. A form of the computer readable storage medium can be any form as long as the computer readable storage medium can store programs and is readable by the apparatus such as a disk type ROM and a solid-state computer storage media. The functions obtained by installation or download in advance in this way can be realized in cooperation with an OS (Operating System) or the like in the apparatus.

In one embodiment, the CPU 31 may be programmed to force a cut operation to be done at the expense of one label of the pair of labels affixed on the front and rear surfaces of the mount, if a degree of misalignment between the pair of labels is beyond a predetermined threshold. In one embodiment, the CPU 31 may also be programmed not to perform a cut operation in the above mentioned situation.

As mentioned above, the label producing device 1 of an illustrative embodiment may be configured to determine a cut point, at which the mount is to be cut, by identifying the range over which the pair of labels are located on the mount and a portion of the mount free of a label. With this configuration, it may be possible to accurately cut the label paper to issue individual labels without any defect.

While certain embodiments have been described, these embodiments have been presented by way of example only, and are not intended to limit the scope of the disclosures. Indeed, the novel methods and devices described herein may be embodied in a variety of other forms. Furthermore, various omissions, substitutions and changes in the form of the methods and devices described herein may be made without departing from the spirit of the inventions. The accompanying claims and their equivalents are intended to cover such forms or modifications as would fall within the scope and spirit of the inventions.

What is claimed is:

1. A label producing device, comprising:
a feeding unit configured to feed a label paper along a paper path, the label paper having a mount and a plurality of labels affixed on the mount and being wrapped in a roll-shape;
a detecting unit configured to detect a transmittance of the label paper;
a determining unit configured to identify a label free portion of the mount, a portion of the mount having one label and a portion of the mount having two labels based on the detected transmittance of the label paper and determine a center of the label free portion of the mount; and
a cutting unit configured to cut the mount fed along the paper path at the center determined by the determining unit.

2. The device of claim 1, further comprising a printing unit placed in proximity to the paper path and configured to print an image on each of the labels.

3. The device of claim 2, wherein the detecting unit is placed in proximity to the paper path and nearer to the feeding unit than the printing unit.

4. The device of claim 1, wherein the determining unit is further configured to identify whether the mount is absent on the paper path and wherein the determining unit is further configured to determine that the mount is absent on the paper path if a magnitude of the transmittance is equal to or less than a first value; determine a portion of the label paper where the transmittance has been detected as the label free portion of the mount if the magnitude of the transmittance is greater than the first value and equal to or less than a second value; determine the portion of the label paper where the transmittance has been detected as the portion of the mount having one label if the magnitude of the transmittance is greater than the second value and equal to or less than a third value; and determine the portion of the label paper where the transmittance has been detected as the portion of the mount having two labels if the magnitude of the transmittance is greater than the third value.

5. A method of processing a label paper in a label producing device, the method comprising:
feeding a label paper along a paper path, the label paper having a mount and a plurality of labels affixed on the mount and being wrapped in a roll-shape;
detecting a thickness of the label paper fed along the paper path and providing a signal corresponding to the detected thickness;
identifying a label free portion of the mount, a portion of the mount having one label and a portion of the mount having two labels based on the detected thickness of the label paper;
determining a center of the label free portion of the mount; and
cutting the mount fed along the paper path at the determined center.

6. The method of claim 5, further comprising printing an image on each of the labels and wherein the printing comprises printing the image on said each of the labels by a printing unit placed in proximity to the paper path.

7. The method of claim 6, wherein the detecting comprises detecting the thickness of the label paper by a detecting unit placed in proximity to the paper path and ahead of the printing unit.

8. The method of claim 5, wherein the identifying comprises identifying whether the mount is absent on the paper path and wherein the identifying further comprises determining that the mount is absent on the paper path if a magnitude of the thickness is equal to or less than a first value; determining a portion of the label paper where the thickness has been detected as the label free portion of the mount if the magnitude of the thickness is greater than the first value and equal to or less than a second value; determining the portion of the label paper where the thickness has been detected as the portion of the mount having one label if the magnitude of the thickness is greater than the second value and equal to or less than a third value; and determining the portion of the label paper where the thickness has been detected as the portion of the mount having two labels if the magnitude of the thickness is greater than the third value.

9. A label producing device comprising:
a feeding unit configured to feed a label paper along a paper path, the label paper having a plurality of labels affixed thereon;
a detecting unit configured to detect a transmittance or a thickness of the label paper; and
a CPU configured to identify a label free portion of the label paper based on the detected transmittance or thickness to determine a cut point in the label free portion.

10. The device of claim 9, wherein the CPU comprises a cut point determining unit configured to determine a center of the label free portion as the cut point.

11. The device of claim 10, further comprising a cutting unit configured to cut the label paper at the center.

12. The device of claim 9, wherein the CPU is further configured to identify the label free portion of the label paper by checking whether the detected transmittance or thickness is within a predetermined range.

13. The device of claim 9, wherein the detecting unit is further configured to detect the transmittance or the thickness of the label paper while the label paper is fed along the paper path.

14. A label producing device comprising:
a feeding unit configured to feed a label paper along a paper path, the label paper having a plurality of labels affixed thereon;
a detecting unit configured to detect transmittances or thicknesses at successive points on the label paper while the label paper is fed along a paper path; and
a controller configured to identify a label free portion of the label paper based on the detected transmittances and determine a cut point in the label free portion.

15. The device of claim 14, wherein the controller comprises a cut point determining unit configured to determine a center of the label free portion as the cut point.

16. The device of claim 15, further comprising a cutting unit configured to cut the label paper at the center.

17. The device of claim 14, wherein the controller is further configured to categorize each of the successive points as belonging to the label free portion of the label paper if the transmittance or thickness detected at the respective point is within a predetermined range.

18. The device of claim 17, wherein the controller is further configured to determine a lengthwise center of the points categorized as belonging to the label free portion as the cut point.

19. The device of claim 14, wherein the detecting unit is further configured to detect the transmittance or thickness of the label paper while the label paper is fed along the paper path.

20. A label producing method comprising:
feeding a label paper along a paper path, the label paper having a plurality of labels affixed thereon;
detecting a transmittance or a thickness of the label paper; and
identifying a label free portion of the label paper based on the detected transmittance or thickness to determine a cut point in the label free portion.
